(19) United States
(12) Patent Application Publication
(10) Pub. No.: US 2024/0311257 A1
(43) Pub. Date: Sep. 19, 2024

(54) PROVIDING INSTANT ACCESS TO A RESTORED BACKUP SNAPSHOT

(71) Applicant: International Business Machines Corporation, Armonk, NY (US)

(72) Inventors: Leo Shyh-Wei Luan, Saratoga, CA (US); Sangeetha Seshadri, Plano, CA (US)

(21) Appl. No.: 18/121,791

(22) Filed: Mar. 15, 2023

(51) Int. Cl. G06F 11/14

(52) U.S. Cl. CPC G06F 11/1469; G06F 11/1451; G06F 11/1464

(57) ABSTRACT

A method, system, and computer program product for providing access to a file backup snapshot that includes creating a target cache volume to restore the backup snapshot, responsive to receiving a request for data not yet loaded by a prefetch, restoring specific data from a file backup snapshot required to fulfill the request, replying to the request with the specific data, and responsive to completing the prefetch to the target cache volume, breaking a cache relationship.

### BACKGROUND

The present invention relates generally to a providing access to a file backup snapshot method, and more particularly, but not by way of limitation, to a system, method, and computer program product to perform an instant restoration (cloning/allowing updates) of a file system backup snapshot that can be accessible through a file system interface or network file system protocol.

Instant access to a file backup snapshot during a restore is a valuable feature. Conventionally, the backup snapshot restore process retrieves the backup data from the backup storage, and oftentimes from slower storage, such as object storage accessed through the S3 protocol, and stores the restored data in a new data volume (a physical or virtual block volume or a file-system volume). Sometimes the backup data is deduped, compressed, and encrypted, and these data processing steps need to be reversed during the restore in order to retrieve the original data.

In conventional techniques, without instant access, a user needs to wait the entire snapshot to be restored in the production storage before the user or application can start accessing the restored volume. This process can take hours for large data volumes (e.g., TBs). Instant access functionality allows the users or programs to start using the new volumes instantly without waiting for the backup data to be fully restored.

Existing conventional approaches to instant restore are based on block volumes used by virtual machines. These conventional approaches use a combination of backup-server-based virtual disk that is instantly available for attachment to a virtual machine (VM) and storage motion to migrate from the backup-server-based virtual disk to a production-storage-based virtual disk, or a combination of an instantly-available production-storage-based virtual disk sitting atop of backup-storage-based virtual disk and a background block-pull process to hydrate the production-storage-based virtual disk with the data in the backup-storage-based virtual disk in the background.

Thereby, there is a technical problem in the art that conventional approaches are all for instant access of backup data in the form of block storage.

### SUMMARY

In view of the above-mentioned problems in the art, the inventors have considered a technical solution to the technical problem in the conventional techniques by providing instant access of backup data in the form of file storage in order to present the backup snapshot to be restored as a source file system (e.g., a file system in user space (FUSE) mount or a network file system (NFS) share export) and create a target file-system volume in the production storage as a cache of the source file system

In an exemplary embodiment, the present invention can provide a computer-implemented method for providing access to a file backup snapshot, the method including creating a target cache volume to restore the backup snapshot, responsive to receiving a request for data not yet loaded by a prefetch, restoring specific data from the file backup snapshot required to fulfill the request, replying to the request with the specific data, and responsive to completing the prefetch to the target cache volume, breaking a cache relationship.

In an alternative exemplary embodiment, the present invention can provide a computer program product for providing access to a file backup snapshot, the computer program product including a computer-readable storage medium having program instructions embodied therewith, the program instructions executable by a computer to cause the computer to perform: creating a target cache volume to restore the backup snapshot, responsive to receiving a request for data not yet loaded by a prefetch, restoring specific data from the file backup snapshot required to fulfill the request, replying to the request with the specific data, and responsive to completing the prefetch to the target cache volume, breaking a cache relationship.

In another exemplary embodiment, the present invention can provide a system for providing access to a file backup snapshot, the system including a processor, and a memory, the memory storing instructions to cause the processor to perform: creating a target cache volume to restore the backup snapshot, responsive to receiving a request for data not yet loaded by a prefetch, restoring specific data from the file backup snapshot required to fulfill the request, replying to the request with the specific data, and responsive to completing the prefetch to the target cache volume, breaking a cache relationship.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 depicts a computing environment 100 according to an embodiment of the present invention;

FIG. 2 exemplarily shows a high-level flow chart for providing access to a backup snapshot method 200 according to an embodiment of the present invention;

FIG. 3 exemplarily depicts a high-level flow chart 300 for an embodiment of the present invention;

FIG. 4 exemplarily depicts a high-level flow chart 400 for step 301 for an embodiment of the present invention;

FIG. 5 exemplarily depicts a high-level flow chart 500 for step 302 for an embodiment of the present invention;

FIG. 6 exemplarily depicts a data flow direct-to-S3 according to an embodiment of the present invention; and

FIG. 7 exemplarily depicts a data flow with vSnap according to an embodiment of the present invention.

### DETAILED DESCRIPTION

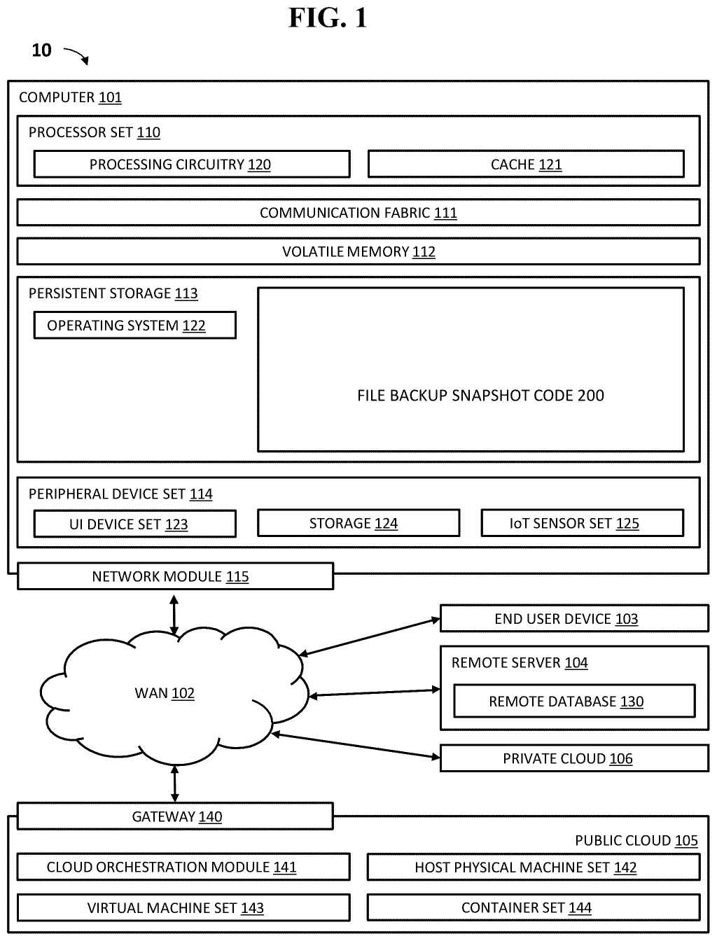

The invention will now be described with reference to FIGS. 1-7, in which like reference numerals refer to like parts throughout. It is emphasized that, according to common practice, the various features of the drawing are not necessarily to scale. On the contrary, the dimensions of the various features can be arbitrarily expanded or reduced for clarity.

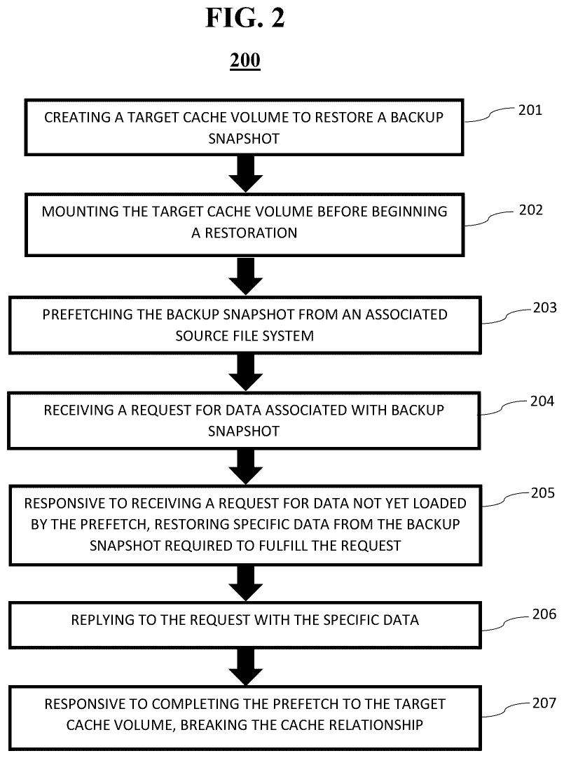

With reference now to the exemplary method 200 depicted in FIG. 2, embodiments of the invention can include various steps for a system that can use a feature and a caching feature of advanced file systems that allows local update to achieve instant restoring/cloning of backup snapshots into the primary storage.

The providing access to a file backup snapshot method 200 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

With reference generally to FIGS. 1-7, embodiments of the invention present a file backup snapshot to be restored as a source file system (e.g., a FUSE mount or an NFS share export) and create the target file-system volume in the production storage as a cache of the source file system.

The target cache volume can be mounted immediately after creation and an on-demand filling of the cache can be provided when data is accessed, while prefetching the entire file volume data from the source file system in the background. The caching relationship can be broken when the target file volume is completed/hydrated with the backup data represented by the source file system.

In embodiments of the invention as shown in FIGS. 1-7, the source file system can be stored in a different format in the backup storage. For example, a snapshot of the production file system can be deduped, compressed, and encrypted before storing into an object backup storage. In this case, the invention can map the file-system contents into space-efficient and secure objects during backup and present a file-system interface during the restore process to be used as the source file system for the cache file volume in the production storage for instant access.

Thereby, the invention as described below provides instant access to file-system backups.

With specific reference to FIG. 2, in step 201, a target cache volume can be created to restore a file backup snapshot.

In step 202, the target cache volume can be mounted before beginning a restoration.

In step 203, the backup snapshot can be prefetched from an associated source file system. And, in step 204, a request can be received for data associated with the backup snapshot. In other words, during the backup, a request can be received for data.

In step 205, responsive to receiving a request for data not yet loaded by the prefetch, specific data can be restored from the backup snapshot that is required to fulfill the request.

In step 206, the request can be replied to with the specific data.

And, in step 207, responsive to completing the prefetch to the target cache volume, the cache relationship can be broken. That is, the cache relationship can be broken with the local-update cache file set and changed into a regular independent file set when fully populated.

Thereby, with the inventive improvement of method 200, the invention can provision a new persistent volume (PV) with a volume snapshot as its source and make it accessible instantly, while hydrating the new PV in the background. This can improve recovery access time from proportional to the PV size (hours for TBs) to independent of the PV sizes (<1 minute).

The target cache volume can be based on active file management (AFM) because the invention leverages a general parallel file system (GPFS) AFM cache feature (Local Updates mode).

In one embodiment, the invention can use a Restic read-only file system in user space (FUSE) mount of a snapshot as the source site of a newly created AFM cache file set for both on-demand access and background prefetch.

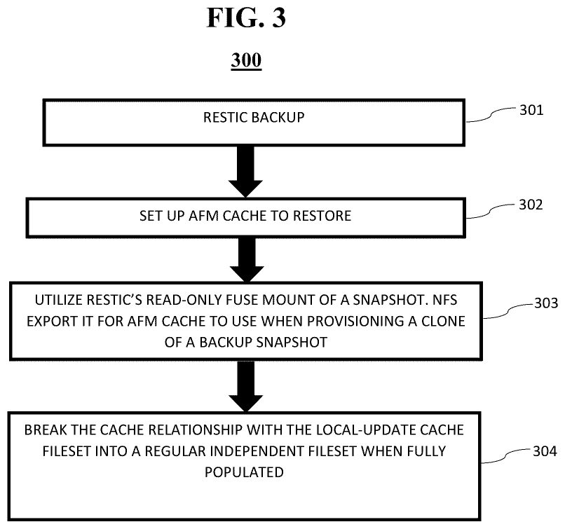

With reference to FIGS. 3-5, method 300 can include steps to be mapped in the invention's control path.

In step 301, Restic backup can be performed. The backup program (e.g., Restic) can backup a snapshot of the fileset and store the backup data in the backup program's storage format in a backup repository.

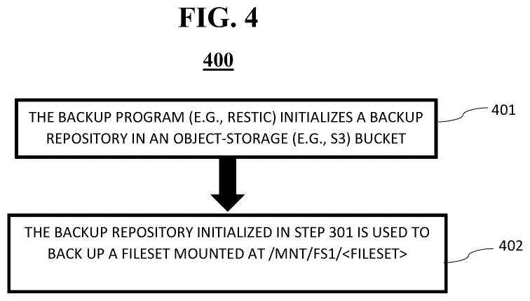

As shown in FIG. 4, for step 301, step 401 can include that the backup program (e.g., Restic) initializes a backup repository in an object-storage (e.g., S3) bucket (e.g., Restic init -r <s3 bucket>).

In step 402, the backup repository initialized in step 401 can be used to back up a fileset mounted at /mnt/fs1/<fileset> (e.g., Restic backup -r <s3 bucket> /mnt/fs1/<filesetname> /.snapshots/ <snapshot id>).

In other words, in step 401, the restic init command for the backup program can create a new repository in the specified S3 bucket. In step 402, the restic backup command can backup the specified snapshot to the s3 backup repository.

In step 302, an AFM cache to restore can be setup. For example, an advanced file management program is used to set up a cache fileset as the target of a backup restore.

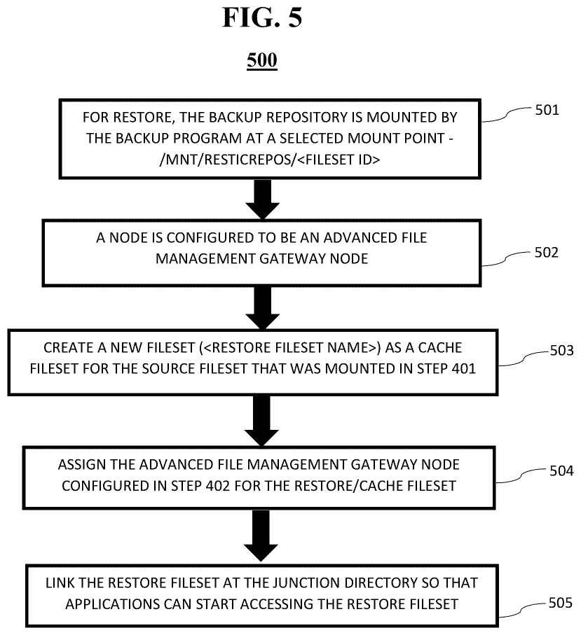

Steps 501-505 are shown in FIG. 5 for executing step 302.

Step 501 can include for restore, the backup repository can be mounted by the backup program at a selected mount point - /mnt/resticrepos/<fileset id> (e.g., Restic -r <s3 bucket> mount /mnt/ResticRepos/<fileset id>).

Step 502 can include a node that is configured to be an Advanced File Management (AFM) gateway node. The AFM gateway node can be responsible for copying file data from the mounted backup repository in step 501 to the cache fileset upon access (e.g., mmchnode -N <AFM gateway node name> --gateway).

Step 503 can include creating a new fileset (e.g., <restore fileset name>) as a cache fileset for the source fileset mounted in Step 501. This also can configure the local-update (LU) cache mode for the cache fileset, which means that the contents of the cache fileset can be updated locally. Any locally updated part of the fileset no longer needs to be retrieved from the source fileset upon further access. The new cache fileset can become the restore fileset. For example, as a code segment, step 503 includes mmcrfileset fs1 <restore fileset name> --inode- space=new -p afmMode=lu,afmTarget=genericfs:///mnt/ResticRepos/<fileset id> (i.e., the FUSE mount of a Restic backup repo).

Step 504 can include assigning the AFM gateway node configured in step 502 for the restore/cache fileset (e.g., mmchfileset fs1 <restore fileset name> -p afmGateway=<AFM gateway node name>).

And, step 505 can include linking the restore fileset at the junction directory so that applications can start accessing the restore fileset (e.g., mmlinkfileset fs1 <restore fileset name> -J /mnt/fs1/<restore fileset name>).

In other words, in steps 501-505, Restic can be used to create a VFS FUSE mount of a selected backup snapshot stored in the S3 storage. The VFS-mounted snapshot can then be configured as the source of a newly created cache fileset, which can then become the target of restore allowing instant access.

In step 303, Restic's read-only FUSE mount of a snapshot can be utilized. Specifically, step 303 can set up a VFS mount of a selected snapshot from the backup repository for restore. Optionally, step 303 can export the VFS mount through NFS. Through the VFS mount or NFS export, an AFM program can be used to set up a cache fileset as the target of the restore operation, which becomes a clone of the backup snapshot, available instantly. The cache fileset can be configured to be in local-update mode, which means that new production data can be written locally into the cache without being propagated back to the source (e.g., the backup repository) and file blocks updated locally in the cache do not need to be retrieved from the source (e.g., the backup repository) upon access.

For example, in step 303, NFS export can be used for the AFM cache when provisioning a clone of a file backup snapshot by mmafmctl fs1 prefetch -j <restore fileset> --directory /mnt/fs1/<restore fileset> --prefetch-threads <nThreads>.

And, in step 304, the cache relationship can be broken with the local-update cache fileset into a regular independent fileset when fully populated (e.g., mmchfileset fs1 <restore fileset> -p afmTarget=disable).

That is, in step 304, once the cache fileset is fully populated, the cache relationship can be broken between the restore fileset and the source backup repository. The restore fileset can become a regular fileset and no longer depends on the backup repository for data access.

In another embodiment, the invention can use the parameters field in the “VolumeContentSource message” within “Create VolumeRequent” to encode the AFM cache fileset parameters.

The “VolumeContentSource message” can include string source_volume_id, string name, <string, string> secrets [(csi_secret)=true], and map<string, string> parameters where specific parameters can be passed in as opaque key-value pairs. This field can be optional. The plugin can be responsible for parsing and validating these parameters. These can be treated as opaque.

Use cases for opaque parameters can include policy to automatically clean up the snapshot, an expiration date for the snapshot, whether the snapshot is read-only or read/write, if the snapshot should be replicated to some place, primary or secondary for replication systems that support snapshotting only on primary, etc.

The “CreateVolumeRequest” can include the field “//.” If “//” is specified, the new volume can be pre-populated with data from the “//.” source. It should be noted that this field is optional where VolumeContentSource volume_content_source=6. It should be noted that “//” specifies what source will be used to create the volume and a type field associated with “//” must be specified.

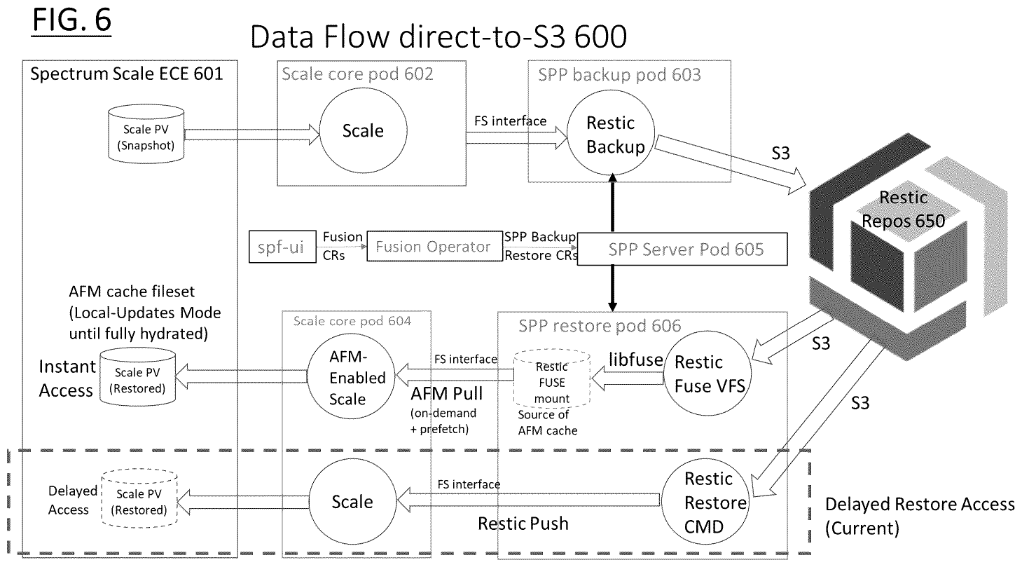

FIG. 6 exemplarily depicts a data flow “direct-to-S3” architecture 600. That is, FIG. 6 depicts an embodiment in a Kubernetes/Openshift environment, where the invention can be used to provide instant access to a restored persistent volume (PV) while the backup data is being restored from a Restic backup repository stored in S3 storage.

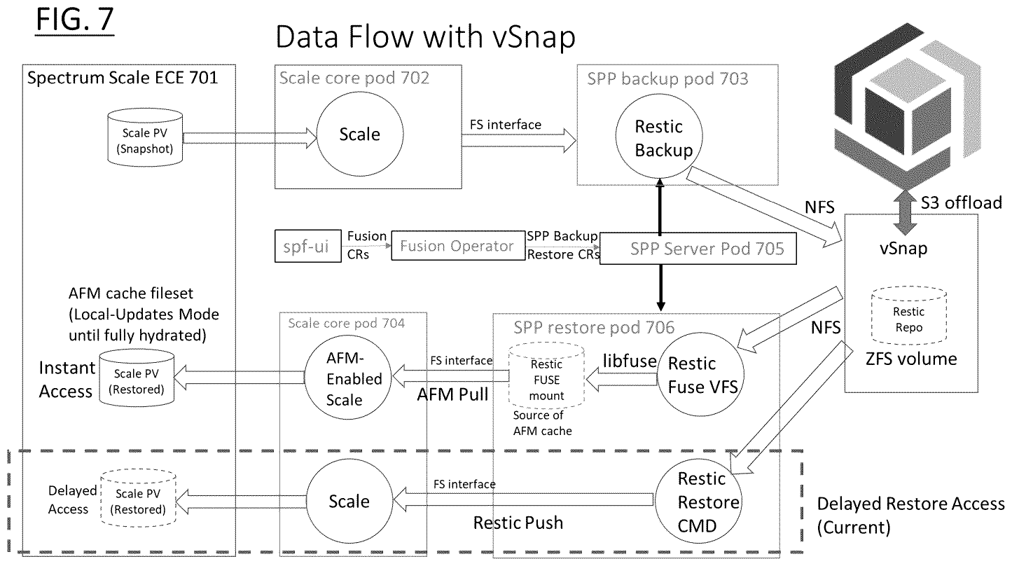

FIG. 7 exemplarily depicts a data flow with vSnap 700. That is, FIG. 7 depicts another embodiment in a Kubernetes/Openshift environment, where a file-storage backup repository is used in the backend to store backup snapshots created by Restic, where this invention can be used to provide instant access to a restored persistent volume (PV) while the backup data is being restored from a Restic backup repository stored in vSnap/ZFS.

The snapshot may also be offloaded from ZFS to S3 storage in a variation of this embodiment and accessed through vSnap/ZFS during the restore process.

### Exemplary Aspects, Using a Computing Environment 100

With reference now to FIG. 1, computing environment 100 contains an example of an environment for the execution of at least some of the computer code involved in performing the inventive methods, such as file backup snapshot code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented method for providing access to a file backup snapshot, the method comprising:
creating a target cache volume to restore the file backup snapshot;
responsive to receiving a request for data not yet loaded by a prefetch, restoring specific data from the file backup snapshot required to fulfill the request;
replying to the request with the specific data; and
responsive to completing the prefetch to the target cache volume, breaking a cache relationship.

2. The computer-implemented method for providing access to the file backup snapshot of claim 1, wherein the prefetch includes prefetching the backup snapshot from an associated source file system.

3. The computer-implemented method for providing access to the file backup snapshot of claim 2, wherein the source file system includes at least one of:
a file system in user space (FUSE) mount; and
a network file system (NFS) share export.

4. The computer-implemented method for providing access to the file backup snapshot of claim 2, wherein the source file system is stored in a different format in the backup snapshot.

5. The computer-implemented method for providing access to the file backup snapshot of claim 1, wherein the target cache volume is based on active file management (AFM).

6. The computer-implemented method for providing access to the file backup snapshot of claim 1, wherein the target cache volume is read-only.

7. The computer-implemented method for providing access to the file backup snapshot of claim 1, embodied in a cloud-computing environment.

8. A computer program product for providing access to a file backup snapshot, the computer program product comprising a computer-readable storage medium having program instructions embodied therewith, the program instructions executable by a computer to cause the computer to perform:
creating a target cache volume to restore the backup snapshot;
responsive to receiving a request for data not yet loaded by a prefetch, restoring specific data from the file backup snapshot required to fulfill the request;
replying to the request with the specific data; and
responsive to completing the prefetch to the target cache volume, breaking a cache relationship.

9. The computer program product of claim 8, wherein the prefetch includes prefetching the backup snapshot from an associated source file system.

10. The computer program product of claim 9, wherein the source file system includes at least one of:
a file system in user space (FUSE) mount; and
a network file system (NFS) share export.

11. The computer program product of claim 9, wherein the source file system is stored in a different format in the backup snapshot.

12. The computer program product of claim 8, wherein the target cache volume is based on active file management (AFM).

13. The computer program product of claim 8, wherein the target cache volume is read-only.

14. A system for providing access to a file backup snapshot, the system comprising:
a processor; and
a memory, the memory storing instructions to cause the processor to perform:
creating a target cache volume to restore the backup snapshot;
responsive to receiving a request for data not yet loaded by a prefetch, restoring specific data from the file backup snapshot required to fulfill the request;
replying to the request with the specific data; and
responsive to completing the prefetch to the target cache volume, breaking a cache relationship.

15. The system for providing access to the file backup snapshot of claim 14, wherein the prefetch includes prefetching the backup snapshot from an associated source file system.

16. The system for providing access to the file backup snapshot of claim 15, wherein the source file system includes at least one of:
a file system in user space (FUSE) mount; and
a network file system (NFS) share export.

17. The system for providing access to the file backup snapshot of claim 15, wherein the source file system is stored in a different format in the backup snapshot.

18. The system for providing access to the file backup snapshot of claim 14, wherein the target cache volume is based on active file management (AFM).

19. The system for providing access to the file backup snapshot of claim 14, wherein the target cache volume is read-only.

20. The system for providing access to the file backup snapshot of claim 14, embodied in a cloud-computing environment.
